(19) United States
(12) Patent Application Publication
(10) Pub. No.: US 2017/0269809 A1
(43) Pub. Date: Sep. 21, 2017

(54) METHOD FOR SCREEN CAPTURE AND ELECTRONIC DEVICE

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Yanying QIAN, Beijing (CN)

(21) Appl. No.: 15/246,984

(22) Filed: Aug. 25, 2016

Related U.S. Application Data
(63) Continuation of application No. PCT/CN2016/089337, filed on Jul. 8, 2016.

(30) Foreign Application Priority Data
Mar. 21, 2016 (CN) 201610161985.5

(51) Int. Cl. G06F 3/0488; G06F 3/041; G11B 27/00; G06F 3/0484

(52) U.S. Cl. CPC G06F 3/0488; G06F 3/0484; G06F 3/0416; G11B 27/005; G06F 2203/04105

(57) ABSTRACT

A method for screen capture. The method includes: upon receipt of a slow play instruction, playing a video at a predetermined slowing rate in a video playing interface of a terminal device, the predetermined slowing rate being less than a normal play rate of the video; receiving a screen capture instruction during the course of playing the video at the predetermined slowing rate; and performing screen capture for the video playing interface according to the screen capture instruction.

### CROSS REFERENCE TO RELATED APPLICATIONS

The present disclosure is a continuation application of PCT International patent application No. PCT/CN2016/089337, filed on Jul. 8, 2016, which claims priority to Chinese Patent Application No. 201610161985.5, filed with the Chinese Patent Office on Mar. 21, 2016, both of which are herein incorporated by reference in their entireties.

### TECHNICAL FIELD

The present disclosure relates to the technical field of data processing, and more particularly speaking, a method for screen capture and electronic device.

### BACKGROUND

With the rapid development and drastic popularity of intelligent electronic devices, users use intelligent electronic devices increasingly tend to watch their interested and desired movies, TVs, entertainment programs and the like by using video-playing software.

A screen capture function is a relatively matured technology in video software. For common users, when finding their interested content, the users generally capture the content by pressing a screen capture button or a screen capture shortcut operation, such that the content is enjoyed or may be shared to their friends or family members.

### SUMMARY

An embodiment of the present disclosure provides a method for screen capture, including:

playing a video at a predetermined slowing rate in a video playing interface of a terminal device upon receipt of a slow play instruction, the predetermined slowing rate being less than a normal playing rate of the video;

receiving a screen capture instruction during the course of playing the video at the predetermined slowing rate; and

performing screen capture for the video playing interface according to the screen capture instruction.

Another embodiment of the present disclosure provides an electronic device, the electronic device includes: at least one processor, and a memory. The memory is communicably connected with the at least one processor and for storing instructions executable by the at least one processor. Wherein execution of the instructions by the at least one processor causes the at least one processor to:

receive a slow play instruction in a video playing interface of a terminal device;

play a video at a predetermined slowing rate upon receipt of the slow play instruction, the

predetermined slowing rate being less than a normal play rate of the video;

receive a screen capture instruction during the course of playing the video at the predetermined slowing rate; and

perform screen capture for the video playing interface according to the screen capture instruction.

Still another embodiment of the present disclosure provides a non-transitory computer-readable storage medium. The non-transitory computer-readable storage medium stores executable instructions, wherein when the executable instructions are executed by an electronic device, causes the electronic device to:

receive a slow play instruction in a video playing interface of a terminal device;

play a video at a predetermined slowing rate upon receipt of the slow play instruction, the predetermined slowing rate being less than a normal play rate of the video;

receive a screen capture instruction during the course of playing the video at the predetermined slowing rate; and

perform screen capture for the video playing interface according to the screen capture instruction.

### BRIEF DESCRIPTION OF THE DRAWINGS

To describe embodiments of the present disclosure or the technical solution in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is a schematic flowchart illustrating a method for screen capture according to one embodiment of the present disclosure;

FIG. 2 is a schematic flowchart illustrating a method for screen capture according to another embodiment of the present disclosure; and

FIG. 3 is a schematic structural diagram illustrating an apparatus for screen capture in terms of modules according to one embodiment of the present disclosure.

FIG. 4 is a schematic structural diagram illustrating an apparatus for screen capture according to one embodiment of the present disclosure.

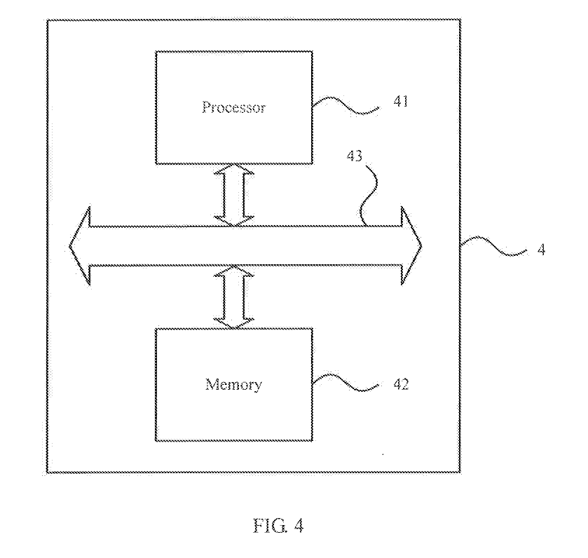

### DETAILED DESCRIPTION

To make the objectives, technical solutions, and advantages of the present disclosure clearer, the present disclosure is described in detail with reference to the accompanying drawings and specific embodiments.

It should be noted that, the terms “first” and “second” used in the embodiments of the present disclosure are two non-identical entities or non-identical parameters having the identical name. It is apparent that the terms “first” and “second” are given herein for illustration convenience, and shall not be construed as limiting the embodiments of the present disclosure. Such terms are not described in the following embodiments any further.

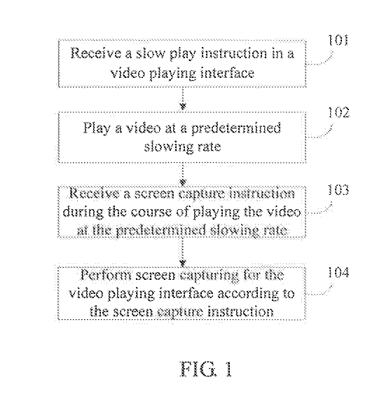

One exemplary embodiment of the present disclosure provides a method for screen capture helping a user to more accurately capture screen. As illustrated in FIG. 1, a schematic flowchart illustrating a method for screen capture according to one embodiment of the present disclosure is given.

The method for screen capture includes the following steps:

In step 101, A slow play instruction is received in a video playing interface of a terminal device; wherein the video playing interface is a display region of a video software on a touch screen, and may be further a displaying interface of video content, that is, a location of a playing window; and the slow play instruction may also be an instruction issued after the touch screen of the terminal device is touched in a predetermined touch manner, or may be an instruction issued after a slow play button displayed in advance in the video playing interface is clicked.

In Step 102: A video is played at a predetermined slowing rate in the video playing interface of the terminal device, wherein the predetermined slowing rate is less than a normal play rate of the video.

In Step 103: A screen capture instruction is received during the course of playing the video at the predetermined slowing rate, wherein the screen capture instruction may be received after it is detected that a screen capture button on the screen is clicked, or may be received after a touch gesture is detected, or may be received in another manner.

In Step 104: Screen capture is performed for the video playing interface according to the screen capture instruction.

Before using the method for screen capture, the user may have watched a frame to be captured, plays back the video for a specific period of time, then slows the video play rate by using the slow play instruction, and then captures the frame.

As seen from the above, with the method for screen capture according to the present disclosure, upon receipt of a slow play instruction, a play rate is reduced in a video playing interface of a terminal device, and a screen capture instruction is received and screen capture is performed. Before the screen capture, the play rate is reduced, such that a user is capable of more accurately capture his or her interested frame, which improves screen capture accuracy and enhances user experience.

In some exemplary embodiments, the slow play instruction is a heavy press, and the screen capture instruction is releasing the heavy press; the heavy press refers to a heavy touch with a great press, which may be greater than a press force applied in a normal click, and under some special circumstances, may be equal to the press force applied in the normal click; and the predetermined slowly play rate refers to a predetermined play rate slower than the normal play rate.

The step 104 of performing screen capture for the video playing interface according to the screen capture instruction may further include the following steps:

detecting that the heavy press is released;

determining that the screen capture instruction is received, and recording release time of the heavy press; wherein the slow play instruction is a constant heavy press, and when the heavy press is released, it is determined that the screen capture instruction is received; and

performing screen capture for the video playing interface at the release time

According to the above embodiment, releasing the heavy press is set to the screen capture instruction, such that when the user applies a heavy press to the screen, the play rate is slowed, and screen capture is performed when the user releases the heavy press. In this way, slowing the play rate is associated with the screen capture action, and thus the operations are more convenient.

Further, upon the step 104 of performing screen capture for the video playing interface according to the screen capture instruction, the method may further include the following step:

upon screen capture, continuing playing the video at the normal play rate.

The video play is automatically resumed to the normal play speed upon screen capture, such that the user does not need to manually adjust the play rate to the normal play rate. In some exemplary embodiment, this step is combined with the step of releasing the heavy press as the screen capture instruction. That is, upon heavy pressure release and screen capture, the normal play rate is resumed, such that the rate slowing, screen capture and rate resume are made coherently associated. In this way, this function is more conveniently used by the user, and user experience is enhanced.

Further, in some other embodiments, the heavy press is determined by:

defining a minimum touch pressure threshold, and determining that the slow play instruction is a heavy press if a touch pressure of a touch instruction generated in the video playing interface is greater than or equal to the minimum touch pressure threshold; wherein touch pressure may be detected by using a touch screen equipped with a pressure sensor;

wherein the step 102 of playing a video at a predetermined slowing rate includes the following steps:

parting a range between a value greater than the minimum touch pressure threshold and a value equal to the minimum touch pressure threshold into a plurality of touch pressure threshold intervals, each touch pressure threshold interval corresponding to a predetermined slowing rate; wherein in some exemplary embodiments, touch pressure values in the plurality of touch pressure threshold intervals increase in sequence, and predetermined slowing rates corresponding thereto decrease in sequence;

determining a touch pressure threshold interval of a touch pressure of the heavy press;

selecting, according to the touch pressure threshold interval of the touch pressure of the heavy press, a predetermined slowing rate corresponding to the touch pressure threshold interval; and

playing the video at the selected predetermined slowing rate.

For example, if there are totally three touch pressure threshold intervals, let the minimum touch pressure threshold be A and an upper threshold of a first touch pressure threshold interval be B, then the first touch pressure threshold interval is between A and B; and let an upper threshold of a second touch pressure threshold interval be C, then the second touch pressure threshold interval is between B and C, and a third touch pressure threshold interval is greater than or equal to C, wherein A<B<C; the first touch pressure threshold interval, the second touch pressure threshold interval and the third touch pressure threshold interval respectively correspond to a first predetermined slowing rate, a second predetermined slowing rate and a third predetermined slowing rate; assume that the first predetermined slowing rate is ½ of the normal play rate, the second predetermined slowing rate is ⅓ of the normal play rate and the third predetermined slowing rate is ¼ of the normal play rate, then when the touch pressure falls with the first touch pressure threshold interval, the video is played at the first predetermined slowing rate (a rate which is ½ of the normal play rate).

According to the above embodiment, the touch pressure of the heavy pressure is used as a differentiation criterion to define a plurality of touch pressure threshold intervals, such that the user may adjust the value of the slowing rate according to actual needs.

In some exemplary embodiments, the heavy press is determined by:

defining a minimum touch area threshold, and determining that the slow play instruction is a heavy press if a touch area of a touch instruction generated in the video playing interface is greater than or equal to the minimum touch area threshold;

wherein the step 102 of playing a video at a predetermined slowing rate includes the following steps:

parting a range between a value greater than the minimum touch area threshold and a value equal to the minimum touch area threshold into a plurality of touch area threshold intervals, each touch area threshold interval corresponding to a predetermined slowing rate; wherein in some exemplary embodiments, touch area values in the plurality of touch area threshold intervals increase in sequence, and predetermined slowing rates corresponding thereto decrease in sequence;

determining a touch pressure area interval of a touch area of the heavy press;

selecting, according to the touch area threshold interval of the touch area of the heavy press, a predetermined slowing rate corresponding to the touch area threshold interval; and

playing the video at the selected predetermined slowing rate.

For example, if there are totally three touch area threshold intervals, let the minimum touch area threshold be a and an upper threshold of a first touch area threshold interval be b, then the first touch area threshold interval is between a and b; and let an upper threshold of a second touch area threshold interval be c, then the second touch area threshold interval is between b and c, and a third touch area threshold interval is greater than or equal to c, wherein a<b<c; the first touch area threshold interval, the second touch area threshold interval and the third touch area threshold interval respectively correspond to a fourth predetermined slowing rate, a fifth predetermined slowing rate and a sixth predetermined slowing rate; assume that the fourth predetermined slowing rate is ½ of the normal play rate, the fifth predetermined slowing rate is ⅓ of the normal play rate and the sixth predetermined slowing rate is ¼ of the normal play rate, then when the touch area falls with the first touch area threshold interval, the video is played at the first predetermined slowing rate (a rate which is ½ of the normal play rate).

According to the above embodiment, the touch area of the heavy pressure is used as a differentiation criterion to define a plurality of touch area threshold intervals, such that the user may adjust the value of the slowing rate according to actual needs.

,In some other exemplary embodiments, the heavy press is determined by:

defining a minimum touch pressure threshold and a minimum touch area threshold, and determining that the slow play instruction is a heavy press if a touch pressure of a touch instruction is greater than or equal to the minimum touch pressure threshold and a touch area of a touch instruction generated in the video playing interface is greater than or equal to the minimum touch area threshold;

wherein the step 102 of playing a video at a predetermined slowing rate includes the following steps:

parting a range between a value greater than the minimum touch pressure threshold and a value equal to the minimum touch pressure threshold into a plurality of touch pressure threshold intervals, and parting a range between a value greater than the minimum touch area threshold and a value equal to the minimum touch area threshold into a plurality of touch area threshold intervals; wherein in some exemplary embodiments, touch pressure values in the plurality of touch pressure threshold intervals increase in sequence, touch area values in the plurality of touch area threshold intervals increase in sequence, the number of touch pressure threshold intervals is the same as the number of touch area threshold intervals, and the touch pressure threshold intervals are one-to-one corresponding to the touch area threshold intervals in an ascending order; for example, if there are totally three touch pressure threshold intervals, let the minimum touch pressure threshold be A and an upper threshold of a first touch pressure threshold interval be B, then the first touch pressure threshold interval is between A and B; and let an upper threshold of a second touch pressure threshold interval be C, then the second touch pressure threshold interval is between B and C, and a third touch pressure threshold interval is greater than or equal to C, wherein A<B<C; likewise, if there are totally three touch area threshold intervals, let the minimum touch area threshold be a and an upper threshold of a first touch area threshold interval be b, then the first touch area threshold interval is between a and b; and let an upper threshold of a second touch area threshold interval be c, then the second touch area threshold interval is between b and c, and a third touch area threshold interval is greater than or equal to c, wherein a<b<c; the first touch pressure threshold interval, the second touch pressure threshold interval and the third touch pressure threshold interval respectively correspond to the first touch area threshold interval, the touch area threshold interval and the third touch area threshold interval;

defining a plurality of predetermined slowing rates, wherein values of the predetermined slowing rates decrease in sequence and the plurality of predetermined slowing rates are in a one-to-one corresponding relationship with the touch pressure threshold intervals and the touch area threshold intervals; for example, if there are totally three predetermined slowing rates, and assume that a first predetermined slowing rate is ½ of the normal play rate, a second slowing rate is ⅓ of the normal play rate and a third slowing rate is ¼ of the normal play rate, then the first touch pressure threshold interval, the second touch pressure threshold interval and the third touch pressure threshold interval respectively correspond to the first predetermined slowing rate, the second predetermined slowing rate and the third predetermined slowing rate, and meanwhile, the first touch area threshold interval, the second touch area threshold interval and the third touch area threshold interval respectively correspond to the first predetermined slowing rate, the second predetermined slowing rate and the third predetermined slowing rate;

when a touch pressure and a touch area of a heavy press respectively fall within the touch pressure threshold intervals and the touch area threshold intervals in the corresponding relationship, selecting a predetermined slowing rate corresponding to both the touch pressure threshold intervals and the touch pressure area intervals; for example, when the touch pressure falls with the first touch pressure threshold interval and the touch area falls within the first touch area threshold interval, the first predetermined slowing rate (a rate which is ½ of the normal play rate) is selected;

when a touch pressure and a touch area of a heavy press do not respectively fall within the touch pressure threshold intervals and the touch area threshold intervals in the corresponding relationship, determining whether a touch area value of the touch area threshold intervals corresponding to the touch pressure threshold intervals is greater than a touch area value of the touch area threshold intervals within which the touch area of the touch instruction falls;

if the touch area value of the touch area threshold intervals corresponding to the touch pressure threshold intervals is greater than the touch area value of the touch area threshold intervals within which the touch area of the touch instruction falls, selecting a predetermined slowing rate corresponding to the touch pressure threshold intervals; for example, when the touch pressure falls within the first touch pressure threshold interval and the touch area falls within the second touch area threshold interval, the touch area value of the first touch area threshold interval corresponding to the first touch pressure threshold interval is less than the touch area value of the second touch area threshold value, and thus the first predetermined slowing rate (a rate which is ½ of the normal play rate) is selected;

if the touch area value of the touch area threshold intervals corresponding to the touch pressure threshold intervals is less than or equal to the touch area value of the touch area threshold intervals within which the touch area of the touch instruction falls, selecting a predetermined slowing rate corresponding to the touch area threshold intervals; for example, when the touch pressure falls within the third touch pressure threshold interval and the touch area falls within the second touch area threshold interval, the touch area value of the third touch area threshold interval corresponding to the third touch pressure threshold interval is greater than the touch area value of the second touch area threshold value, and thus the second predetermined slowing rate (a rate which is ⅓ of the normal play rate) is selected;

playing the video at the selected predetermined slowing rate.

According to the above embodiment, the touch pressure and the touch area of the heavy pressure are both used as differentiation criteria to define a plurality of touch area threshold intervals, such that the user may adjust the value of the slowing rate according to actual needs and rate adjustment is more accurate.

In some other exemplary embodiments, the method for screen capture is applied to a mobile terminal, and upon the step 103 of playing the video at the predetermined slowing rate, the method further includes the following step:

sending prompt information prompting the user to perform a gravity sensing operation; wherein content of the prompt information is displayed on the screen, and may be “shake to capture screen”, “sway to capture screen” and the like.

The step 104 of receiving a screen capture instruction and performing screen capture for the video playing interface according to the screen capture instruction includes the following step:

receiving the screen capture instruction triggered by the gravity sensing operation, and performing screen capture for the current video playing interface.

Specifically, the screen capture instruction triggered by the gravity sensing operation is determined by:

acquiring data collected by such a built-in device as a gravity sensor or an acceleration sensor or the like;

acquiring an acceleration value by analyzing the data; and

if the acceleration value falls within a predetermined acceleration threshold range, determining that a screen capture instruction is received and performing a corresponding operation.

In some exemplary embodiments, under normal circumstances, a video frame when the user starts shaking the terminal is the frame which the user actually desires to capture, instead of a video frame upon completion of shaking. Therefore, when the acceleration value is acquired via analysis, a start time point when the corresponding data is generated may also be acquired via analysis, and the start time point is recorded. During screen capture, the video frame at the start time point is captured.

Upon the operations in the above embodiment, it is not necessary to resume the normal play rate. In this way, the user may further capture screen by shaking the terminal again, and resuming to the normal play rate may be implemented by a manual control operation.

Defining a screen capture instruction triggered by the gravity sensing operation to capture screen simplifies user's operations and enhances user experience.

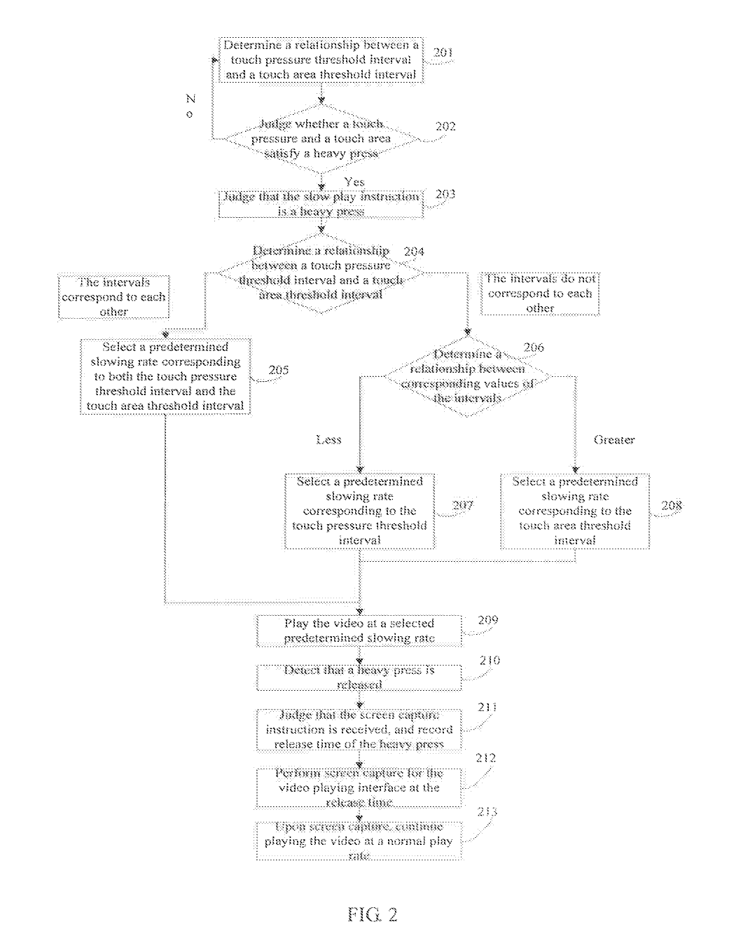

The present disclosure further provides another embodiment illustrating a method for screen capture. As illustrated in FIG. 2, a schematic flowchart of a screen capture according to another embodiment of the present disclosure is given.

The method for screen capture includes the following steps:

In Step 201: In a video playing interface, a touch instruction is received.

In Step 202: It is determined whether a touch pressure of the touch instruction is greater than or equal to a minimum touch pressure threshold, and whether a touch area of the touch instruction is greater than or equal to a minimum touch area threshold.

In Step 203: If the touch pressure of the touch instruction is greater than or equal to the minimum touch pressure threshold, and the touch area of the touch instruction is greater than or equal to the minimum touch area threshold, it is determined that the slow play instruction is a heavy press.

In Step 204: A relationship between touch pressure threshold intervals of the touch pressure of the heavy press and touch area threshold intervals of the touch area of the heavy press is determined.

In Step 205: When a touch pressure and a touch area of a heavy press respectively fall within the touch pressure threshold intervals and the touch area threshold intervals in the corresponding relationship, a predetermined slowing rate corresponding to both the touch pressure threshold intervals and the touch pressure area intervals is selected.

In Step 206: When a touch pressure and a touch area of the heavy press do not respectively fall within the touch pressure threshold intervals and the touch area threshold intervals in the corresponding relationship, it is determined whether a touch area value of the touch area threshold intervals corresponding to the touch pressure threshold intervals is less than a touch area value of the touch area threshold intervals within which the touch area of the touch instruction falls.

In Step 207: If the touch area value of the touch area threshold intervals corresponding to the touch pressure threshold intervals is less than the touch area value of the touch area threshold intervals within which the touch area of the touch instruction falls, a predetermined slowing rate corresponding to the touch pressure threshold intervals is selected.

In Step 208: If the touch area value of the touch area threshold intervals corresponding to the touch pressure threshold intervals is not less than the touch area value of the touch area threshold intervals within which the touch area of the touch instruction falls, a corresponding predetermined slowing rate corresponding to the touch pressure threshold intervals is selected.

In Step 209: The video is played at the selected predetermined slowing rate.

In Step 210: It is detected that the heavy press is released during the course of playing the video at the predetermined slowing rate.

In Step 211: It is determined that the screen capture instruction is received, and record release time of the heavy press.

In Step 212: A video frame at the release time is captured.

In Step 213: Upon screen capture, the video is continuously played at the normal play rate.

As seen from the above embodiment, with the method for screen capture according to the present disclosure, a play rate is lowered upon receipt of a heavy press operation in a video playing interface, screen capture is implemented by releasing the heavy press, and upon screen capture, and video playing resumes to a normal play rate. Before screen capture, lowering the play rate by means of the heavy press enables the user to be capable of more accurately capture his or her interested frame, thereby improving screen capture accuracy. Implementing screen capture by releasing the heavy press and resuming to the normal play rate enable the user to capture screen more conveniently and more coherently, which improves screen capture efficiency and enhances user experience.

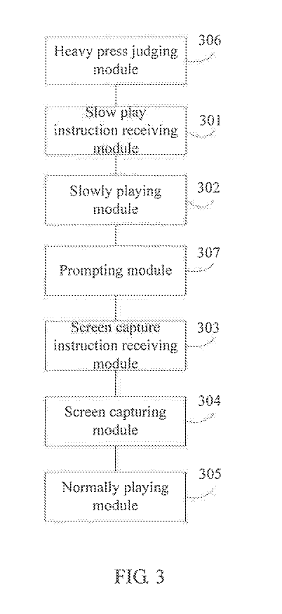

One exemplary embodiment of the present disclosure provides an apparatus for screen capture helping a user to more accurately capture screen. As illustrated in FIG. 3, a schematic structural diagram illustrating an apparatus for screen capture in terms of modules according to one embodiment of the present disclosure is given.

The apparatus for screen capture includes:

a slow play instruction receiving module 301, configured to: receive a slow play instruction in a video playing interface of a terminal device; wherein the video playing interface is a display region of a video software on a touch screen, and may be further a displaying interface of video content, that is, a location of a playing window; and the slow play instruction may also be an instruction issued after the touch screen of the terminal device is touched in a predetermined touch manner, or may be an instruction issued after a slow play button displayed in advance in the video playing interface is clicked;

a slowly playing module 302, configured to, upon receipt of the slow play instruction, play a video at a predetermined slowing rate, the predetermined slowing rate being less than a normal play rate of the video;

a screen capture instruction receiving module 303, configured to receive a screen capture instruction during the course of playing the video at the predetermined slowing rate, wherein the screen capture instruction may be received after it is detected that a screen capture button on the screen is clicked, or may be received after a touch gesture is detected, or may be received in another manner;

a screen capture module 304, configured to perform screen capture for the video playing interface according to the screen capture instruction.

Before using the apparatus for screen capture, the user may have watched a frame to be captured, plays back the video for a specific period of time, then slows the video play rate by using the slow play instruction, and then captures the frame.

As seen from the above, with the apparatus for screen capture according to the present disclosure, upon receipt of a slow play instruction, a play rate is reduced in a video playing interface of a terminal device, and a screen capture instruction is received and screen capture is performed. Before the screen capture, the play rate is reduced, such that a user is capable of more accurately capture his or her interested frame, which improves screen capture accuracy and enhances user experience.

In some exemplary embodiments, the slow play instruction is a heavy press, and the screen capture instruction is releasing the heavy press; the heavy press refers to a heavy touch with a great press, which may be greater than a press force applied in a normal click, and under some special circumstances, may be equal to the press force applied in the normal click; and the predetermined slowly play rate refers to a predetermined play rate slower than the normal play rate.

the screen capture module 304 is specifically configured to:

detect that the heavy press is released;

determine that the screen capture instruction is received, and record release time of the heavy press; wherein the slow play instruction is a constant heavy press, and when the heavy press is released, it is determined that the screen capture instruction is received; and

perform screen capture for the video playing interface at the release time.

According to the above embodiment, releasing the heavy press is set to the screen capture instruction, such that when the user applies a heavy press to the screen, the play rate is slowed, and screen capture is performed when the user releases the heavy press. In this way, slowing the play rate is associated with the screen capture action, and thus the operations are more convenient.

Further, the apparatus for screen capture further includes a normally playing module 305, configured to, upon screen capture, continue playing the video at the normal play rate.

The video play is automatically resumed to the normal play speed upon screen capture, such that the user does not need to manually adjust the play rate to the normal play rate. In some one exemplary embodiments, this step is combined with the step of releasing the heavy press as the screen capture instruction. That is, upon heavy pressure release and screen capture, the normal play rate is resumed, such that the rate slowing, screen capture and rate resume are made coherently associated. In this way, this function is more conveniently used by the user, and user experience is enhanced.

Further, in some exemplary embodiments, the apparatus further includes a heavy press determining module 306, configured to define a minimum touch pressure threshold, and determine that the slow play instruction is a heavy press if a touch pressure of a touch instruction is greater than or equal to the minimum touch pressure threshold; wherein

the slowly playing module 302 is specifically configured to:

part a range between a value greater than the minimum touch pressure threshold and a value equal to the minimum touch pressure threshold into a plurality of touch pressure threshold intervals, each touch pressure threshold interval corresponding to a predetermined slowing rate; wherein in some exemplary embodiments, touch pressure values in the plurality of touch pressure threshold intervals increase in sequence, and predetermined slowing rates corresponding thereto decrease in sequence;

determine a touch pressure threshold interval of a touch pressure of the heavy press;

select, according to the touch pressure threshold interval of the touch pressure of the heavy press, a predetermined slowing rate corresponding to the touch pressure threshold interval; and

play the video at the selected predetermined slowing rate.

For example, if there are totally three touch pressure threshold intervals, let the minimum touch pressure threshold be A and an upper threshold of a first touch pressure threshold interval be B, then the first touch pressure threshold interval is between A and B; and let an upper threshold of a second touch pressure threshold interval be C, then the second touch pressure threshold interval is between B and C, and a third touch pressure threshold interval is greater than or equal to C, wherein A<B<C; the first touch pressure threshold interval, the second touch pressure threshold interval and the third touch pressure threshold interval respectively correspond to a first predetermined slowing rate, a second predetermined slowing rate and a third predetermined slowing rate; assume that the first predetermined slowing rate is ½ of the normal play rate, the second predetermined slowing rate is ⅓ of the normal play rate and the third predetermined slowing rate is ¼ of the normal play rate, then when the touch pressure falls with the first touch pressure threshold interval, the video is played at the first predetermined slowing rate (a rate which is ½ of the normal play rate).

According to the above embodiment, the touch pressure of the heavy pressure is used as a differentiation criterion to define a plurality of touch pressure threshold intervals, such that the user may adjust the value of the slowing rate according to actual needs.

In some other exemplary embodiments, the heavy press determining module 306 is specifically configured to define a minimum touch area threshold, and determine that the slow play instruction is a heavy press if a touch area of a touch instruction generated in the video playing interface is greater than or equal to the minimum touch area threshold; and

the slowly playing module 302 is specifically configured to:

part a range between a value greater than the minimum touch area threshold and a value equal to the minimum touch area threshold into a plurality of touch area threshold intervals, each touch area threshold interval corresponding to a predetermined slowing rate; wherein in some other exemplary embodiments, touch area values in the plurality of touch area threshold intervals increase in sequence, and predetermined slowing rates corresponding thereto decrease in sequence;

determine a touch pressure area interval of a touch area of the heavy press;

select, according to the touch area threshold interval of the touch area of the heavy press, a predetermined slowing rate corresponding to the touch area threshold interval; and

play the video at the selected predetermined slowing rate.

For example, if there are totally three touch area threshold intervals, let the minimum touch area threshold be a and an upper threshold of a first touch area threshold interval be b, then the first touch area threshold interval is between a and b; and let an upper threshold of a second touch area threshold interval be c, then the second touch area threshold interval is between b and c, and a third touch area threshold interval is greater than or equal to c, wherein a<b<c; the first touch area threshold interval, the second touch area threshold interval and the third touch area threshold interval respectively correspond to a fourth predetermined slowing rate, a fifth predetermined slowing rate and a sixth predetermined slowing rate; assume that the fourth predetermined slowing rate is ½ of the normal play rate, the fifth predetermined slowing rate is ⅓ of the normal play rate and the sixth predetermined slowing rate is ¼ of the normal play rate, then when the touch area falls with the first touch area threshold interval, the video is played at the first predetermined slowing rate (a rate which is ½ of the normal play rate).

According to the above embodiment, the touch area of the heavy pressure is used as a differentiation criterion to define a plurality of touch area threshold intervals, such that the user may adjust the value of the slowing rate according to actual needs.

In some other exemplary embodiments, the heavy press determining module 306 is specifically configured to define a minimum touch pressure threshold and a minimum touch area threshold, and determine that the slow play instruction is a heavy press if a touch pressure of a touch instruction generated in the video playing interface is greater than or equal to the minimum touch pressure threshold and a touch area of a touch instruction generated in the video playing interface is greater than or equal to the minimum touch area threshold;

the slowly playing module 302 is specifically configured to:

part a range between a value greater than the minimum touch pressure threshold and a value equal to the minimum touch pressure threshold into a plurality of touch pressure threshold intervals, and part a range between a value greater than the minimum touch area threshold and a value equal to the minimum touch area threshold into a plurality of touch area threshold intervals; wherein in some other exemplary embodiments, touch pressure values in the plurality of touch pressure threshold intervals increase in sequence, touch area values in the plurality of touch area threshold intervals increase in sequence, the number of touch pressure threshold intervals is the same as the number of touch area threshold intervals, and the touch pressure threshold intervals are one-to-one corresponding to the touch area threshold intervals in an ascending order; for example, if there are totally three touch pressure threshold intervals, let the minimum touch pressure threshold be A and an upper threshold of a first touch pressure threshold interval be B, then the first touch pressure threshold interval is between A and B; and let an upper threshold of a second touch pressure threshold interval be C, then the second touch pressure threshold interval is between B and C, and a third touch pressure threshold interval is greater than or equal to C, wherein A<B<C; likewise, if there are totally three touch area threshold intervals, let the minimum touch area threshold be a and an upper threshold of a first touch area threshold interval be b, then the first touch area threshold interval is between a and b; and let an upper threshold of a second touch area threshold interval be c, then the second touch area threshold interval is between b and c, and a third touch area threshold interval is greater than or equal to c, wherein a<b<c; the first touch pressure threshold interval, the second touch pressure threshold interval and the third touch pressure threshold interval respectively correspond to the first touch area threshold interval, the touch area threshold interval and the third touch area threshold interval;

define a plurality of predetermined slowing rates, wherein values of the predetermined slowing rates decrease in sequence and the plurality of predetermined slowing rates are in a one-to-one corresponding relationship with the touch pressure threshold intervals and the touch area threshold intervals; for example, if there are totally three predetermined slowing rates, and assume that a first predetermined slowing rate is ½ of the normal play rate, a second slowing rate is ⅓ of the normal play rate and a third slowing rate is ¼ of the normal play rate, then the first touch pressure threshold interval, the second touch pressure threshold interval and the third touch pressure threshold interval respectively correspond to the first predetermined slowing rate, the second predetermined slowing rate and the third predetermined slowing rate, and meanwhile, the first touch area threshold interval, the second touch area threshold interval and the third touch area threshold interval respectively correspond to the first predetermined slowing rate, the second predetermined slowing rate and the third predetermined slowing rate;

when a touch pressure and a touch area of a touch instruction respectively fall within the touch pressure threshold intervals and the touch area threshold intervals in the corresponding relationship, select a predetermined slowing rate corresponding to both the touch pressure threshold intervals and the touch pressure area intervals; for example, when the touch pressure falls with the first touch pressure threshold interval and the touch area falls within the first touch area threshold interval, the first predetermined slowing rate (a rate which is ½ of the normal play rate) is selected;

when a touch pressure and a touch area of a touch instruction do not respectively fall within the touch pressure threshold intervals and the touch area threshold intervals in the corresponding relationship, determine whether a touch area value of the touch area threshold intervals corresponding to the touch pressure threshold intervals is less than a touch area value of the touch area threshold intervals within which the touch area of the touch instruction falls;

if the touch area value of the touch area threshold intervals corresponding to the touch pressure threshold intervals is greater than the touch area value of the touch area threshold intervals within which the touch area of the touch instruction falls, select a predetermined slowing rate corresponding to the touch pressure threshold intervals; for example, when the touch pressure falls within the first touch pressure threshold interval and the touch area falls within the second touch area threshold interval, the touch area value of the first touch area threshold interval corresponding to the first touch pressure threshold interval is less than the touch area value of the second touch area threshold value, and thus the first predetermined slowing rate (a rate which is ½ of the normal play rate) is selected;

if the touch area value of the touch area threshold intervals corresponding to the touch pressure threshold intervals is less than or equal to the touch area value of the touch area threshold intervals within which the touch area of the touch instruction falls, select a predetermined slowing rate corresponding to the touch area threshold intervals; for example, when the touch pressure falls within the third touch pressure threshold interval and the touch area falls within the second touch area threshold interval, the touch area value of the third touch area threshold interval corresponding to the third touch pressure threshold interval is greater than the touch area value of the second touch area threshold value, and thus the second predetermined slowing rate (a rate which is ⅓ of the normal play rate) is selected;

play the video at the selected predetermined slowing rate.

According to the above embodiment, the touch pressure and the touch area of the heavy pressure are both used as differentiation criteria to define a plurality of touch area threshold intervals, such that the user may adjust the value of the slowing rate according to actual needs and rate adjustment is more accurate.

In some other exemplary embodiments, the apparatus for screen capture is a mobile terminal and further includes:

a prompting module 307, configured to send prompt information prompting the user to perform a gravity sensing operation; wherein content of the prompt information is displayed on the screen, and may be “shake to capture screen”, “sway to capture screen” and the like;

wherein the screen capture instruction receiving module 303 is configured to receive the screen capture instruction triggered by the gravity sensing operation; and

the screen capturing module 304 is configured to perform screen capturing for the current video playing interface.

Specifically, the screen capture instruction triggered by the gravity sensing operation is determined by:

acquiring data collected by such a built-in device as a gravity sensor or an acceleration sensor or the like;

acquiring an acceleration value by analyzing the data;

if the acceleration value falls within a predetermined acceleration threshold range, determining that a screen capture instruction is received and performing a corresponding operation.

In some other exemplary embodiments, under normal circumstances, a video frame when the user starts shaking the terminal is the frame which the user actually desires to capture, instead of a video frame upon completion of shaking. Therefore, when the acceleration value is acquired via analysis, a start time point when the corresponding data is generated may also be acquired via analysis, and the start time point is recorded. During screen capture, the video frame at the start time point is captured.

Upon the operations in the above embodiment, it is not necessary to resume the normal play rate. In this way, the user may further capture screen by shaking the terminal again, and resuming to the normal play rate may be implemented by a manual control operation.

Defining a screen capture instruction triggered by the gravity sensing operation to capture screen simplifies user's operations and enhances user experience.

Persons of ordinary skill in the art should understand that the discussion of any of the above embodiments is exemplary, and is not intended to imply that the scope of the present disclosure (including the claims) is limited to these exemplary embodiments. The above embodiments, or the technical features in different embodiments may be combined, and various modifications may be made to different aspects of the present disclosure, which are not described in detail for brevity. Therefore, any omission, modification, equivalent replacement, or improvement made without departing from the spirit and principle of the present disclosure should fall within the protection scope of the present disclosure.

What is claimed is:

1. A method for screen capture, comprising:
at a terminal device,
playing a video at a predetermined slowing rate in a video playing interface of a terminal device upon receipt of a slow play instruction, the predetermined slowing rate being less than a normal play rate of the video;
receiving a screen capture instruction during the course of playing the video at the predetermined slowing rate; and
performing screen capture for the video playing interface according to the screen capture instruction.

2. The method according to claim 1, wherein the slow play instruction is a heavy press, and the screen capture instruction is releasing the heavy press; and
the performing screen capture for the video playing interface according to the screen capture instruction comprises:
detecting that the heavy press is released;
determining that the screen capture instruction is received, and recording release time of the heavy press; and
performing screen capture for the video playing interface at the release time.

3. The method according to claim 1, wherein the method is applied to a mobile terminal;
upon the playing a video at a predetermined slowing rate, the method comprises:
sending prompt information for prompting a user to perform an gravity sensing operation; and
the step of receiving a screen capture instruction and performing screen capture for the video playing interface according to the screen capture instruction comprises:
receiving the screen capture instruction triggered by the gravity sensing operation, and performing screen capture for the current video playing interface.

4. The method according to claim 2, wherein the heavy press is determined by:
defining a minimum touch pressure threshold, and determining that the slow play instruction is a heavy press if a touch pressure of a touch instruction generated in the video playing interface is greater than or equal to the minimum touch pressure threshold;
wherein the playing a video at a predetermined slowing rate comprises:
parting a range between a value greater than the minimum touch pressure threshold and a value equal to the minimum touch pressure threshold into a plurality of touch pressure threshold intervals, each touch pressure threshold interval corresponding to a predetermined slowing rate;
determining a touch pressure threshold interval of a touch pressure of the heavy press;
selecting, according to the touch pressure threshold interval of the touch pressure of the heavy press, a predetermined slowing rate corresponding to the touch pressure threshold interval; and
playing the video at the selected predetermined slowing rate;
or the heavy press is determined by:
defining a minimum touch area threshold, and determining that the slow play instruction is a heavy press if a touch area of a touch instruction generated in the video playing interface is greater than or equal to the minimum touch area threshold;
wherein the playing a video at a predetermined slowing rate comprises:
parting a range between a value greater than the minimum touch area threshold and a value equal to the minimum touch area threshold into a plurality of touch area threshold intervals, each touch pressure area interval corresponding to a predetermined slowing rate;
determining a touch pressure area interval of a touch area of the heavy press;
selecting, according to the touch area threshold interval of the touch area of the heavy press, a predetermined slowing rate corresponding to the touch area threshold interval; and
playing the video at the selected predetermined slowing rate.

5. The method according to claim 2, wherein the heavy press is determined by:
defining a minimum touch pressure threshold and a minimum touch area threshold, and determining that the slow play instruction is a heavy press if a touch pressure of a touch instruction generated in the video playing interface is greater than or equal to the minimum touch pressure threshold and a touch area of a touch instruction generated in the video playing interface is greater than or equal to the minimum touch area threshold;
the playing a video at a predetermined slowing rate comprises:
parting a range between a value greater than the minimum touch pressure threshold and a value equal to the minimum touch pressure threshold into a plurality of touch pressure threshold intervals, and parting a range between a value greater than the minimum touch area threshold and a value equal to the minimum touch area threshold into a plurality of touch area threshold intervals, the number of touch pressure threshold intervals being the same as the number of touch area threshold intervals, the touch pressure threshold intervals being one-to-one corresponding to the touch area threshold intervals in an ascending order;
wherein a plurality of predetermined slowing rates are in a one-to-one corresponding relationship with the touch pressure threshold intervals and the touch area threshold intervals;
when a touch pressure and a touch area of a touch instruction respectively fall within the touch pressure threshold intervals and the touch area threshold intervals in the corresponding relationship, selecting a predetermined slowing rate corresponding to both the touch pressure threshold intervals and the touch pressure area intervals;
when a touch pressure and a touch area of a touch instruction do not respectively fall within the touch pressure threshold intervals and the touch area threshold intervals in the corresponding relationship, determining whether a touch area value of the touch area threshold intervals corresponding to the touch pressure threshold intervals is greater than a touch area value of the touch area threshold intervals within which the touch area of the touch instruction falls;
if the touch area value of the touch area threshold intervals corresponding to the touch pressure threshold intervals is greater than the touch area value of the touch area threshold intervals within which the touch area of the touch instruction falls, selecting a predetermined slowing rate corresponding to the touch pressure threshold intervals;
if the touch area value of the touch area threshold intervals corresponding to the touch pressure threshold intervals is less than the touch area value of the touch area threshold intervals within which the touch area of the touch instruction falls, selecting a predetermined slowing rate corresponding to the touch area threshold intervals;
playing the video at the selected predetermined slowing rate.

6. An electronic device, comprising:
at least one processor; and
a memory communicably connected with the at least one processor for storing instructions executable by the at least one processor, wherein execution of the instructions by the at least one processor causes the at least one processor to:
receive a slow play instruction in a video playing interface of a terminal device;
play a video at a predetermined slowing rate upon receipt of the slow play instruction, the predetermined slowing rate being less than a normal play rate of the video;
receive a screen capture instruction during the course of playing the video at the predetermined slowing rate; and
perform screen capture for the video playing interface according to the screen capture instruction.

7. The electronic device according to claim 6, wherein the slow play instruction is a heavy press, and the screen capture instruction is releasing the heavy press; the execution of the instructions by the at least one processor causes the at least one processor to:
detect that the heavy press is released;
determine that the screen capture instruction is received, and record release time of the heavy press; and
perform screen capture for the video playing interface at the release time.

8. The electronic device according to claim 6, wherein the execution of the instructions by the at least one processor causes the at least one processor to:
send prompt information for prompting a user to perform an gravity sensing operation;
receive the screen capture instruction triggered by the gravity sensing operation; and
perform screen capture for the current video playing interface.

9. The electronic device according to claim 6, wherein the execution of the instructions by the at least one processor causes the at least one processor to:
define a minimum touch pressure threshold, and determine that the slow play instruction is a heavy press if a touch pressure of a touch instruction generated in the video playing interface is greater than or equal to the minimum touch pressure threshold;
part a range between a value greater than the minimum touch pressure threshold and a value equal to the minimum touch pressure threshold into a plurality of touch pressure threshold intervals, each touch pressure threshold interval corresponding to a predetermined slowing rate;
determine a touch pressure threshold interval of a touch pressure of the heavy press;
select, according to the touch pressure threshold interval of the touch pressure of the heavy press, a predetermined slowing rate corresponding to the touch pressure threshold interval; and
play the video at the selected predetermined slowing rate.

10. The electronic device according to claim 6, wherein the execution of the instructions by the at least one processor causes the at least one processor to:
define a minimum touch area threshold, and determine that the slow play instruction is a heavy press if a touch area of a touch instruction generated in the video playing interface is greater than or equal to the minimum touch area threshold; and
the slowly playing module is specifically configured to:
partition a range between a value greater than the minimum touch area threshold and a value equal to the minimum touch area threshold into a plurality of touch area threshold intervals, each touch pressure area interval corresponding to a predetermined slowing rate; and determine a touch pressure area interval of a touch area of the heavy press;
select, according to the touch area threshold interval of the touch area of the heavy press, a predetermined slowing rate corresponding to the touch area threshold interval; and
play the video at the selected predetermined slowing rate.

11. The electronic device according to claim 6, wherein the execution of the instructions by the at least one processor causes the at least one processor to:
define a minimum touch pressure threshold and a minimum touch area threshold, and determine that the slow play instruction is a heavy press if a touch pressure of a touch instruction generated in the video playing interface is greater than or equal to the minimum touch pressure threshold and a touch area of a touch instruction generated in the video playing interface is greater than or equal to the minimum touch area threshold;
part a range between a value greater than the minimum touch pressure threshold and a value equal to the minimum touch pressure threshold into a plurality of touch pressure threshold intervals, and part a range between a value greater than the minimum touch area threshold and a value equal to the minimum touch area threshold into a plurality of touch area threshold intervals, the number of touch pressure threshold intervals being the same as the number of touch area threshold intervals, the touch pressure threshold intervals being one-to-one corresponding to the touch area threshold intervals in an ascending order;
wherein a plurality of predetermined slowing rates are in a one-to-one corresponding relationship with the touch pressure threshold intervals and the touch area threshold intervals;
when a touch pressure and a touch area of a touch instruction respectively fall within the touch pressure threshold intervals and the touch area threshold intervals in the corresponding relationship, select a predetermined slowing rate corresponding to both the touch pressure threshold intervals and the touch pressure area intervals;
when a touch pressure and a touch area of a touch instruction do not respectively fall within the touch pressure threshold intervals and the touch area threshold intervals in the corresponding relationship, determine whether a touch area value of the touch area threshold intervals corresponding to the touch pressure threshold intervals is greater than a touch area value of the touch area threshold intervals within which the touch area of the touch instruction falls;
if the touch area value of the touch area threshold intervals corresponding to the touch pressure threshold intervals is greater than the touch area value of the touch area threshold intervals within which the touch area of the touch instruction falls, select a predetermined slowing rate corresponding to the touch pressure threshold intervals;
if the touch area value of the touch area threshold intervals corresponding to the touch pressure threshold intervals is less than the touch area value of the touch area threshold intervals within which the touch area of the touch instruction falls, select a predetermined slowing rate corresponding to the touch area threshold intervals; and
play the video at the selected predetermined slowing rate.

12. The non-transitory computer-readable storage medium, storage medium storing executable instructions, wherein the execution of the instructions is executed by electronic device, causes the electronic device to :
receive a slow play instruction in a video playing interface of a terminal device;
play a video at a predetermined slowing rate upon receipt of the slow play instruction, the predetermined slowing rate being less than a normal play rate of the video;
receive a screen capture instruction during the course of playing the video at the predetermined slowing rate; and
perform screen capture for the video playing interface according to the screen capture instruction.

13. The non-transitory computer-readable storage medium according to claim 12, wherein the slow play instruction is a heavy press, and the screen capture instruction is releasing the heavy press; the execution of the instructions is executed by electronic device, causes the electronic device to:
detect that the heavy press is released;
determine that the screen capture instruction is received, and record release time of the heavy press; and
perform screen capture for the video playing interface at the release time.

14. The non-transitory computer-readable storage medium according to claim 12, wherein the execution of the instructions is executed by electronic device, causes the electronic device to :
send prompt information for prompting a user to perform an gravity sensing operation;
receive the screen capture instruction triggered by the gravity sensing operation; and
perform screen capture for the current video playing interface.

15. The non-transitory computer-readable storage medium according to claim 12, wherein the execution of the instructions is executed by electronic device, causes the electronic device to:
define a minimum touch pressure threshold, and determine that the slow play instruction is a heavy press if a touch pressure of a touch instruction generated in the video playing interface is greater than or equal to the minimum touch pressure threshold;
part a range between a value greater than the minimum touch pressure threshold and a value equal to the minimum touch pressure threshold into a plurality of touch pressure threshold intervals, each touch pressure threshold interval corresponding to a predetermined slowing rate;
determine a touch pressure threshold interval of a touch pressure of the heavy press;
select, according to the touch pressure threshold interval of the touch pressure of the heavy press, a predetermined slowing rate corresponding to the touch pressure threshold interval; and
play the video at the selected predetermined slowing rate.

16. The non-transitory computer-readable storage medium according to claim 12, wherein the execution of the instructions is executed by electronic device, causes the electronic device to :
define a minimum touch area threshold, and determine that the slow play instruction is a heavy press if a touch area of a touch instruction generated in the video playing interface is greater than or equal to the minimum touch area threshold; and
the slowly playing module is specifically configured to:
part a range between a value greater than the minimum touch area threshold and a value equal to the minimum touch area threshold into a plurality of touch area threshold intervals, each touch pressure area interval corresponding to a predetermined slowing rate; and determine a touch pressure area interval of a touch area of the heavy press;
select, according to the touch area threshold interval of the touch area of the heavy press, a predetermined slowing rate corresponding to the touch area threshold interval; and
play the video at the selected predetermined slowing rate.

17. The non-transitory computer-readable storage medium according to claim 12, wherein the execution of the instructions is executed by electronic device, causes the electronic device to:
define a minimum touch pressure threshold and a minimum touch area threshold, and determine that the slow play instruction is a heavy press if a touch pressure of a touch instruction generated in the video playing interface is greater than or equal to the minimum touch pressure threshold and a touch area of a touch instruction generated in the video playing interface is greater than or equal to the minimum touch area threshold;
part a range between a value greater than the minimum touch pressure threshold and a value equal to the minimum touch pressure threshold into a plurality of touch pressure threshold intervals, and part a range between a value greater than the minimum touch area threshold and a value equal to the minimum touch area threshold into a plurality of touch area threshold intervals, the number of touch pressure threshold intervals being the same as the number of touch area threshold intervals, the touch pressure threshold intervals being one-to-one corresponding to the touch area threshold intervals in an ascending order;
wherein a plurality of predetermined slowing rates are in a one-to-one corresponding relationship with the touch pressure threshold intervals and the touch area threshold intervals;
when a touch pressure and a touch area of a touch instruction respectively fall within the touch pressure threshold intervals and the touch area threshold intervals in the corresponding relationship, select a predetermined slowing rate corresponding to both the touch pressure threshold intervals and the touch pressure area intervals;
when a touch pressure and a touch area of a touch instruction do not respectively fall within the touch pressure threshold intervals and the touch area threshold intervals in the corresponding relationship, determine whether a touch area value of the touch area threshold intervals corresponding to the touch pressure threshold intervals is greater than a touch area value of the touch area threshold intervals within which the touch area of the touch instruction falls;
if the touch area value of the touch area threshold intervals corresponding to the touch pressure threshold intervals is greater than the touch area value of the touch area threshold intervals within which the touch area of the touch instruction falls, select a predetermined slowing rate corresponding to the touch pressure threshold intervals;
if the touch area value of the touch area threshold intervals corresponding to the touch pressure threshold intervals is less than the touch area value of the touch area threshold intervals within which the touch area of the touch instruction falls, select a predetermined slowing rate corresponding to the touch area threshold intervals; and
play the video at the selected predetermined slowing rate.
